(19) United States
(12) Patent Application Publication
(10) Pub. No.: US 2015/0059602 A1
(43) Pub. Date: Mar. 5, 2015

(54) PRINTING PRESS

(71) Applicant: KOMORI CORPORATION, Tokyo (JP)

(72) Inventor: Hiroyoshi KAMODA, Tsukuba-shi (JP)

(21) Appl. No.: 14/471,948

(22) Filed: Aug. 28, 2014

(30) Foreign Application Priority Data
Aug. 29, 2013 (JP) 2013-177536

(51) Int. Cl. B41F 11/00; B41F 13/18; B41F 13/193; B41F 9/02

(52) U.S. Cl. CPC B41F 11/00; B41F 9/021; B41F 13/18; B41F 13/193
USPC 101/136; 101/174

(57) ABSTRACT

A printing press includes: an upper collect printing unit configured to perform collect printing in which multi-color printing is performed by applying inks of multiple colors at once, on a top surface of a conveyed sheet; and a lower collect printing unit configured to perform collect printing in which multi-color printing is performed by applying inks of multiple colors at once, on a bottom surface of the conveyed sheet.

### TECHNICAL FIELD

The present invention relates to a printing press capable of performing collect printing on a sheet.

### BACKGROUND ART

Collect printing has been conventionally provided as a special printing method in which multi-color printing can be performed at once by partially applying inks of different colors on one plate surface. The collect printing not only has a characteristic that the color of an image line can be changed in the middle of the line without misregistration but also has a characteristic that no misalignment occurs at all. Due to these characteristics, the collect printing is employed more often in cases where anti-counterfeit of a printed product is intended.

A printing press employing the collect printing described above is disclosed in, for example, Patent Literature 1.

### CITATION LIST

### Patent Literature

(Patent Literature 1) Japanese Patent Application Publication No. 2003-127321

### SUMMARY OF INVENTION

### Technical Problem

In the aforementioned conventional printing press, a collect printing part capable of performing collect printing is provided. The collect printing part performs collect printing on one surface of a conveyed sheet. Specifically, the conventional printing press performs collect printing only on one surface of the sheet in one pass from feeding to delivery of the sheet and cannot perform collect printing on both surfaces of the sheet.

The present invention has been made to solve the problem described above and an object thereof is to provide a printing press capable of performing collect printing on both surfaces of a sheet in one pass.

### Solution to Problem

A printing press according to a first aspect of the present invention for solving the problem described above includes: a first collect printing unit configured to perform collect printing in which multi-color printing is performed by applying inks of multiple colors at once, on one surface of a conveyed sheet; and a second collect printing unit configured to perform collect printing in which multi-color printing is performed by applying inks of multiple colors at once, on another surface of the conveyed sheet.

A printing press according to a second aspect of the present invention for solving the problem described above further includes an offset printing unit configured to perform offset printing on the conveyed sheet.

In a printing press according to a third aspect or the present invention for solving the problem described above, the offset printing unit is provided downstream of the first collect printing unit end the second collect printing unit in a sheet conveying direction and performs offset printing on the sheet subjected to collect printing by the first collect printing unit and the second collect printing unit.

In a printing press according to a fourth aspect of the present invention for solving the problem described above, the first collect printing unit includes: a first impression cylinder configured to hold and convey the sheet; and a first collect printing device disposed above the first impression cylinder and facing the first impression cylinder, and the second collect printing unit includes: a second impression cylinder configured to hold and convey the sheet; and a second collect printing device disposed below the second impression cylinder and facing the second impression cylinder.

### Advantageous Effects of Invention

As described above, the printing press of the present invention includes the first collect printing unit configured to perform collect printing on the one surface of the sheet and the second collect printing unit configured to perform collect printing on the other surface of the sheet and can thereby perform collect printing on both surfaces of the sheet in one pass.

### BRIEF DESCRIPTION OF DRAWINGS

FIG. 1 is a schematic configuration diagram of a printing press in one embodiment of the present invention.

### DESCRIPTION OF EMBODIMENT

A printing press of the present invention is described below in detail by using the drawing.

### Embodiment

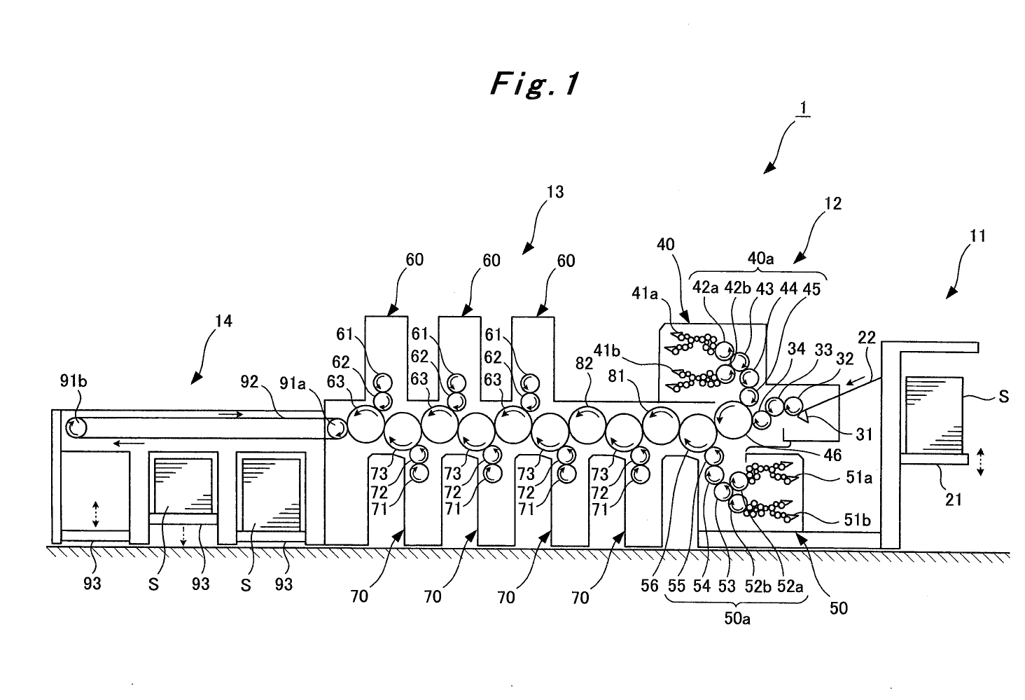

As shown in FIG. 1, a printing press 1 can sequentially perform two types of printing of collect printing and offset printing on sheets S. Specifically, in the printing press 1, a sheet feeding part 11, a collect printing part 12, an offset printing part 13, and a sheet delivery part 14 are arranged in this order from an upstream side to a downstream side in a sheet conveying direction.

The sheet feeding part 11 includes a feeding tray 21 and a feeding board 22 provided downstream of the feeding tray 21 in the sheet conveying direction.

The feeding tray 21 is a tray on which the sheets S before printing are stacked and is supported to be capable of being lifted and lowered in an up-down direction. Moreover, the feeding board 22 is interposed between the sheet feeding part 11 and the collect printing part 12 and is inclined downward toward the downstream side in the sheet conveying direction. An upstream end portion of the feeding board 22 in the sheet conveying direction faces a forward edge portion of the top one of the sheets S stacked on the feeding tray 21 while a downstream end portion of the feeding board 22 in the sheet transfer direction is disposed inside the collect printing part 12.

Accordingly, by lifting the feeding tray 21 on which the sheets S are stacked stepwise according to the thickness of each sheet S, the top one of the sheets S stacked on the feeding tray 21 is sent out to the downstream end portion of the feeding board 22 in the sheet conveying direction.

The collect printing part 12 performs collect printing in which multi-color printing is performed by applying inks of multiple colors at once, sequentially on top surface (one surface) and a bottom surface (another surface) of each of the sheets S. Specifically, in the collect printing part 12, a swing arm shaft pregripper 31; transfer cylinders 32, 33, and 34, an upper collect printing unit (first collect printing unit) 40, and a lower collect printing unit (second collect printing unit) 50 are arranged in this order from the upstream side to the downstream side in the sheet conveying direction.

The swing arm shaft pregripper 31 is supported to be swingable between the transfer cylinder 32 and the downstream end portion of the feeding board 22 in the sheet conveying direction, and the forward edge portion of each sheet S fed to the feeding board 22 can be passed to the transfer cylinder 32. Moreover, the transfer cylinders 32, 33, 34 facing one another are rotatably supported and can grip the forward edge portion of the sheet S. An impression cylinder 46 of the upper collect printing unit 40 rotatably faces a portion of the transfer cylinder 34 which is downstream of a position facing the transfer cylinder 33 in a rotating direction (downstream in the sheet transfer direction).

Each sheet S sent out to the feeding board 22 is thus gripped by the swing arm shaft pregripper 31 upon reaching the downstream end portion of the feeding board 22 in the sheet conveying direction and then passed to the transfer cylinder 32.

The upper collect printing unit 40 performs collect printing in which multi-color printing is performed by applying inks of multiple colors at once, on the top surface of the sheet S.

Here, the upper collect painting unit 40 includes: inking devices (first inking devices) 41a, 41b which can supply inks of different colors respectively; partial plate cylinders (first partial plate cylinders) 42a, 42b which are in contact with the inking devices 41a, 41b respectively; a collecting blanket cylinder (first collecting blanket cylinder) 43 which is in contact with both of the partial plate cylinders 42a, 42b; a collecting plate cylinder (first collecting plate cylinder) 44 which is in contact with the collecting blanket cylinder 43; a blanket cylinder (first blanket cylinder) 45 which is in contact with the collecting plate cylinder 44; and the impression cylinder (first impression cylinder) 46 which faces the blanket cylinder 45 in a portion downstream of a position facing the transfer cylinder 34 in a rotating direction and which holds and conveys the sheet S received from the transfer cylinder 34.

Groups of rolls forming the inking devices 41a, 41b and the cylinders 42a, 42b, 43, 44, 45, 46 are rotatably supported. Moreover, the inking devices 41a, 41b are double-duct type inking devices capable of supplying inks of different colors in their respective roll axis directions and more ink colors can be thus used in the upper collect printing unit 40 including the inking devices 41a, 41b. Furthermore, the partial plate cylinder 42a, 42b, the collecting blanket cylinder 43, the collecting plate cylinder 44, and the blanket cylinder 45 form an upper collect printing device (first collect printing device) 40a.

Specifically, the collecting blanket cylinder 43 is rotatably in contact with portions of the partial plate cylinders 42a, 42b which are downstream of contact positions with the inking devices 41a, 41b in rotating directions (downstream in an ink supplying direction). Moreover, the collecting plate cylinder 44 is rotatably in contact with a portion of the collecting blanket cylinder 43 which is downstream of contact positions with the partial plate cylinders 42a, 42b in a rotating direction (downstream in the ink supplying direction). Furthermore, the blanket cylinder 45 is rotatably in contact with a portion of the collecting plate cylinder 44 which is downstream of a contact position with the collecting blanket cylinder 43 in a rotating direction (downstream in the ink supplying direction). Moreover, the impression cylinder 46 rotatably faces a portion of the blanket cylinder 45 which is downstream of a contact position with the collecting plate cylinder 44 in a rotating direction (downstream in the ink supplying direction). Furthermore, an impression cylinder 56 of the lower collect printing unit 50 to be described later is rotatably in contact with a portion of the impression cylinder 46 which is downstream of a position facing the blanket cylinder 45 in the rotating direction (downstream in the ink supplying direction).

In other words, as described above, one upper collect printing device 40a and the inking devices 41a, 41b of the upper collect printing unit 40 are arranged above the sheet S conveyed by the impression cylinder 46.

Accordingly, the inks or different colors supplied from the inking devices 41a, 41b are supplied to the collecting blanket cylinder 43 via the partial place cylinders 42a, 42b and are thereby integrated on an outer peripheral surface of the collecting blanket cylinder 43. Next, the integrated inks of at least two colors are supplied to the blanket cylinder 45 via the collecting plate cylinder 44 and are then transferred to the sheet S conveyed by the impression cylinder 46.

Meanwhile, the lower collect printing unit 50 performs collect printing in which multi-color printing is performed by applying inks of multiple colors at once, on the bottom surface of the sheet S.

Here, the lower collect printing unit 50 includes: inking devices (second inking devices) 51a, 51b which can supply inks of different colors respectively; partial plate cylinders (second partial plate cylinders) 52a, 52b which are in (second collecting blanket cylinder) 53 which is in contact with both of the partial plate cylinders 52a, 52b; a collecting plate cylinder (second collecting plate cylinder) 54 which is in contact with the collecting blanket cylinder 53; a blanket cylinder (second blanket cylinder) 55 which is in contact with the collecting plate cylinder 54; and the impression cylinder (second impression cylinder) 56 which faces the blanket cylinder 55 in a portion downstream of a position facing the impression cylinder 46 in a rotating direction and which holds and conveys the sheet S received from the impression cylinder 46.

Groups of rolls forming the inking devices 51a, 51b and the cylinders 52a, 52b, 53, 54, 55, 56 are rotatably supported. Moreover, the inking devices 51a, 51b are double-duct type inking devices capable of supplying inks of different colors in their respective roll axis directions and more ink colors can be thus used in the lower collect printing unit 50 including the inking devices 51a, 51b. Furthermore, the partial plate cylinders 52a, 52b, the collecting blanket cylinder 53, the collecting plate cylinder 54, and the blanket cylinder 55 form a lower collect printing device (second collect printing device) 50a.

Specifically, the collecting blanket cylinder 53 is rotatably in contact with portions of the partial plate cylinders 52a, 52b which are downstream of contact positions with the inking devices 51a, 51b in rotating directions (downstream in an ink supplying direction). Moreover, the collecting plate cylinder 54 is rotatably in contact with a portion of the collecting blanket cylinder 53 which is downstream of contact positions with the partial plate cylinders 52a, 52b in a rotating direction (downstream in the ink supplying direction). Furthermore, the blanket cylinder 55 is rotatably in contact with a portion of the collecting plate cylinder 54 which is downstream of the contact position with the collecting blanket cylinder 53 in a rotating direction (downstream in the ink supplying direction). Moreover, the impression cylinder 56 rotatably faces a portion of the blanket cylinder 55 which is downstream of the contact position with the collecting plate cylinder 54 in the rotating direction (downstream in the ink supplying direction).

A transfer cylinder 81 rotatably faces a portion of the impression cylinder 56 which is downstream of a position facing the blanket cylinder 55 in the rotating direction (downstream in the sheet conveying direction) and an impression cylinder 73 of a lower first color (rower first stage) in the offset printing part 13 to be described later is rotatably in contact with a portion of the transfer cylinder 81 which is downstream of a position facing the impression cylinder 56 in a rotating direction (downstream in the sheet conveying direction).

In other words, as described above, the lower collect printing device 50a and the inking devices 51a, 51b of the lower collect printing unit 50 are arranged below the sheet S conveyed by the impression cylinder 56.

Accordingly, the inks of different colors supplied from the inking devices 51a, 51b are supplied to the collecting blanket cylinder 53 via the partial plate cylinders 52a, 52b and are thereby integrated on an outer peripheral surface of the collecting blanket cylinder 53. Next, the integrated inks of at least two colors are supplied to the blanket cylinder 55 via the collecting plate cylinder 54 and are then transferred to the sheet S conveyed by the impression cylinder 56.

The offset printing part 13 performs offset printing on the top and bottom surfaces of the sheet S subjected to collect printing. Specifically, in the offset printing part 13, three upper offset printing units (first offset printing units; 60 and four lower offset printing units (second offset printing units) 70 are alternately arranged from the upstream side to the downstream side in the sheet conveying direction.

The upper offset printing units 60 perform offset printing on the top surface of the sheet S. Note that the three upper offset printing units 60 perform offset printing by using inks of different colors respectively and offset printing of three colors is performed on the top surface of the sheet S.

Here, each of the upper offset printing units 60 includes: a plate cylinder 61 to which the ink is supplied; a blanket cylinder 62 which is in contact with the plate cylinder 61; and an impression cylinder 63 which faces the blanket cylinder 62 and which holds and conveys the sheet S. Note that the plate cylinder 61, the blanket cylinder 62, and the impression cylinder 63 are rotatably supported.

Specifically, the impression cylinder 63 rotatably faces a portion of the blanket cylinder 62 which is downstream of a contact position with the plate cylinder 61 in a rotating direction (downstream in an ink supplying direction). In each of the upper offset printing units 60 of the upper first color (upper first stage) and the upper second color (upper second stage), an impression cylinder 73 of the corresponding lower offset printing unit 70 to be described later rotatably faces a portion of the impression cylinder 63 which is downstream of a position facing the blanket cylinder 62 in a rotating direction (downstream in the sheet conveying direction). Moreover, in the upper offset printing unit 60 of the upper third color (upper third stage), a delivery chain 92 of the sheet delivery part 14 to be described later faces the portion of the impression cylinder 63 which is downstream of the position facing the blanket cylinder 62 in the rotating direction (downstream in the sheet conveying direction), to be capable of travelling.

The ink supplied to the plate cylinder 61 is thus supplied to the blanket cylinder 62 in contact with the plate cylinder 61 and then transferred to the sheet S conveyed by the impression cylinder 63.

Meanwhile, the lower offset printing emits 70 perform offset printing on the bottom surface of the sheet S. Note that the four lower offset printing units 70 perform offset printing by using inks of different colors respectively and offset printing of four colors is performed on the bottom surface of the sheet S.

Here, each of the lower offset printing units 70 includes: a plate cylinder 71 to which the ink is supplied; a blanket cylinder 72 which is in contact with the plate cylinder 71; and the impression cylinder 73 which faces the blanket cylinder 72 and which holds and conveys the sheet S. Note that the plate cylinder 71, the blanket cylinder 72, and the impression cylinder 73 are rotatably supported.

Specifically, the impression cylinder 73 rotatably faces a portion of the blanket cylinder 72 which is downstream of a contact position with the plate cylinder 71 in a rotating direction (downstream in an ink supplying direction). In the lower offset printing unit 70 of the lower first color (lower first stage), a transfer cylinder 82 rotatably faces a portion of the impression cylinder 73 which is downstream of a position facing the blanket cylinder 72 in a rotating direction (downstream in the sheet conveying direction). Moreover, in each of the lower offset printing units 70 of the lower second color (lower second stage) to the lower fourth color (lower fourth stage), the impression cylinder 63 of the corresponding upper offset printing unit 60 rotatably faces the portion of the impression cylinder 73 which is downstream of the position facing the blanket cylinder 72 in the rotating direction (downstream in the sheet transfer direction).

Note that the transfer cylinder 82 is arranged between the impression cylinder 73 of the lower first color and the impression cylinder 73 of the lower second color. Specifically, the impression cylinder 73 of the lower second color is rotatably supported downstream of a position in the transfer cylinder 82 which faces the impression cylinder 73 of the lower first color in a rotating direction (downstream in the sheet conveying direction).

Accordingly, the ink supplied to the plate cylinder 71 is supplied to the blanket cylinder 72 facing the plate cylinder 71 and then transferred to the sheet S conveyed by the impression cylinder 73.

The sheet delivery unit 14 includes a pair of front and rear sprockets 91a, 91b which are rotatably supported, the delivery chain 92 which is wound around between the sprockets 91a, 91b, and three delivery trays 93 provided below the delivery chain 92.

The delivery chain 92 can selectively deliver the printed sheets S received from the impression cylinder 63 of the upper third color to the three delivery trays 93. Moreover, the delivery trays 93 are trays on which the printed sheets S delivered from the delivery chain 92 are stacked, and are supported to be capable of being lifted and lowered in the up-down direction.

The delivery chain 92 thus delivers each of the printed sheets S to a predetermined one of the delivery trays 93 and the delivery trays 93 are lowered stepwise according to the thickness of the delivered sheet S. A top surface of the top one of the sheets S stacked on each of the delivery trays 93 is thereby always maintained at a fixed height.

As shown in FIG. 1, due to the configuration described above, first the sheets S stacked on the feeding tray 21 of the sheet feeding part 11 are sent out one by one to the feeding board 22 and then passed to the impression cylinder 46 of the upper collect printing unit 40 via the swing arm shaft pregripper 31 and the transfer cylinders 32, 33, 34.

Then, the integrated inks of at least two colors are transferred to the top surface of each of the sheets S conveyed by the impression cylinder 46 of the upper collect printing unit 40 when the sheet S passes through the position where the blanket cylinder 45 and the impression cylinder 46 face each other. Thereafter, the sheet S is passed to the impression cylinder 56 of the lower collect printing unit 50.

Next, the integrated inks of at least two colors are transferred to the bottom surface of the sheet S conveyed by the impression cylinder 56 of one lower collect printing unit 50 when the sheet S passes through the position where the blanket cylinder 55 and the impression cylinder 56 face each other, and the sheet S is then passed to the transfer cylinder 81. Thereafter, the sheet S conveyed by the transfer cylinder 81 and subjected to the collect printing on both surfaces are passed to the impression cylinder 73 of the lower offset printing unit 70 of the lower first color.

Subsequently, the ink of lower first color is transferred to the bottom surface of the sheet S conveyed by the impression cylinder 73 of the lower first color when the sheet S passes through the position where the blanket cylinder 72 and the impression cylinder 73 face each other, and the sheet S is then passed to the transfer cylinder 82. Thereafter, the sheet S conveyed by the transfer cylinder 82 is passed to the impression cylinder 73 of the lower offset printing unit 70 of the lower second color.

Next, the ink of the lower second color is transferred to the bottom surface of the sheet S conveyed by the impression cylinder 73 of the lower second color when the sheet S passes through the position where the blanket cylinder 72 and the impression cylinder 73 face each other, and the sheet S is then passed to the impression cylinder 63 of the upper offset printing unit 60 of the upper first color.

Subsequently, the ink of the upper first color is transferred to the top surface of the sheet S conveyed by the impression cylinder 63 of the upper first color when the sheet S passes through the position where the blanket cylinder 62 and the impression cylinder 63 face each other, and the sheet S is then passed to the impression cylinder 73 of the lower offset printing unit 70 of the lower third color.

Next, the ink of the lower third color is transferred to the bottom surface of the sheet S conveyed by the impression cylinder 73 of the lower third color when the sheet S passes through the position where the blanket cylinder 72 and the impression cylinder 73 face each other, and the sheet S is then passed to the impression cylinder 63 of the upper offset printing unit 60 of the upper second color.

Subsequently, the ink of the upper second color is transferred to the top surface of the sheet S conveyed by the impression cylinder 63 of the upper second color when the sheet S passes through the position where the blanket cylinder 62 and the impression cylinder 63 face each other, and the sheet S is then passed to the impression cylinder 73 of the lower offset printing unit 70 of the lower fourth color.

Next, the ink of the lower fourth color is transferred to the bottom surface of the sheet S conveyed by the impression cylinder 73 of the lower fourth color when the sheet S passes through the position where the blanket cylinder 72 and the impression cylinder 73 face each other, and the sheet S is then passed to the impression cylinder 63 of the upper offset printing unit 60 of the upper third color.

Subsequently, the ink of the upper third color is transferred to the top surface of the sheet S conveyed by the impression cylinder 63 of the upper third color when the sheet S passes through the position where the blanket cylinder 62 and the impression cylinder 63 face each other, and the sheet S is then passed to the delivery chain 92.

The sheet S which has been subjected to collect printing and offset printing on both sides is made to travel by the delivery chain 92 and is then delivered to a predetermined one of the delivery trays 93.

Note that, although the collect printing part 12 and the offset printing part 13 are arranged in this order from the upstream side to the downstream side in the sheet, conveying direction in the embodiment described above, the arrangement order of these parts may be reversed.

Moreover, in the case of providing the offset printing part 13, it is only necessary for the offset printing part 13 to include at least one of a set of the upper offset printing units 60 and a set of the offset printing units 70.

Furthermore, although the upper collect printing unit 40 and the lower collect printing unit 50 for performing collect printing are grouped as the collect printing part 12 while the upper offset printing units 60 and the lower offset printing units 70 for performing the offset printing are grouped as the offset printing part 13, this grouping is unnecessary for the printing press as a whole.

In this case, the arrangement order are numbers of the upper collect printing unit 40, the lower collect printing unit 50, the upper offset printing units 60, and the lower offset printing units 70 can be changed as needed depending on the number of colors (number of ink colors) and the like on each of the top and bottom surfaces of the sheets S which are printed final products.

As described above, the printing press 1 of the present invention includes the upper collect printing unit 40 configured to perform collect printing on the top surface of each of the sheets S and the lower collect printing unit 50 configured to perform collect printing on the bottom surface of the sheet S and can thereby perform collect printing on both surfaces of the sheet S in one pass.

Moreover, providing the upper offset printing units 60 and the lower offset printing units 70 downstream of the upper collect printing unit 40 and the lower collect printing unit 50 in the sheet conveying direction enables offset printing on both surfaces of the sheet S subjected to collect printing on both surfaces. The collect printing and the offset printing can be thus performed on both surfaces of the sheet S in one pass.

### INDUSTRIAL APPLICABILITY

The present invention can be applied to a printing press intended to make a printing position of collect printing variable on a sheet conveying route.

### REFERENCE SIGNS LIST

1 PRINTING PRESS
11 SHEET FEEDING PART
11 COLLECT PRINTING PART
13 OFFSET PRINTING PART
14 SHEET DELIVERY PART
40 UPPER COLLECT PRINTING UNIT
40a UPPER COLLECT PRINTING DEVICE
41a, 41b INKING DEVICE
46 IMPRESSION CYLINDER
50 LOWER COLLECT PRINTING UNIT
50a LOWER COLLECT PRINTING DEVICE
51a, 51b INKING DEVICE
56 IMPRESSION CYLINDER
60 UPPER OFFSET PRINTING UNIT
70 LOWER OFFSET PRINTING UNIT
S SHEET

1. A printing press comprising:
a first collect printing unit configured to perform collect printing in which multi-color printing is performed by applying inks of multiple colors at once, on one surface of a conveyed sheet; and
a second collect printing unit configured to perform collect printing in which multi-color printing is performed by applying inks of multiple colors at once, on another surface of the conveyed sheet.

2. The printing press according to claim 1, further comprising an offset printing unit configured to perform offset printing on the conveyed sheet.

3. The printing press according to claim 2, wherein the offset printing unit is provided downstream of the first collect printing unit and the second collect printing unit in a sheet conveying direction and performs offset printing on the sheet subjected to collect printing by the first collect printing unit and the second collect printing unit.

4. The printing press according to claim 1, wherein
the first collect printing unit includes:
a first impression cylinder configured to hold and convey the sheet; and
a first collect printing device disposed above the first impression cylinder and facing the first impression cylinder, and
the second collect printing unit includes:
a second impression cylinder configured to hold and convey the sheet; and
a second collect printing device disposed below the second impression cylinder and facing the second impression cylinder.
